(19) United States
(12) Patent Application Publication
(10) Pub. No.: US 2002/0147717 A1
(43) Pub. Date: Oct. 10, 2002

(54) Communication device, system, method, and computer program product for sorting data based on proximity

(76) Inventors: Mark Alexander Barros, Hallandale, FL (US); Rami Chaim Levy, Plantation, FL (US)

Correspondence Address: Motorola, Inc., Intellectual Property Section, Law Department, 1500 Gateway Blvd, Boynton Beach, FL, 33426-8292, US

(21) Appl. No.: 09/769,938

(22) Filed: Jan. 26, 2001

(51) Int. Cl. G06F 7/00

(52) U.S. Cl. 707/7

(57) ABSTRACT

A proximity sorting system, method and computer program product for sorting data is provided including a communication device featuring a processor operative to access a plurality of records and position information. The communication device can include a processor operative to sort the plurality of records based on a first detected position and is operative to resort the records based on a second detected position. The device can further feature a detector that detects a change in position of a user device.

The communication device can feature a detector having a positioning device; a global positioning system; a receiver operative to receive position information; or three or more receivers operative to detect by triangulating the position. The communication device can further include a transmitter that can transmit a change in position of the user device, a storage device operative to store and retrieve said records and position information, or a zone detector operative to receive zone information. The communication device can feature a zone detector that can respond to the zone information wherein the zone information is externally definable and responsive to a user signal; or network signal. The communication device can further feature a user interface wherein the zone detector features detecting a zone responsive to a user input signal; a network signal; a position detector; a user identifiable zone; and a non-user identifiable zone.

### FIELD OF THE INVENTION

The present invention relates generally to data processing systems, and more particularly to data processing systems having sorting algorithms.

### BACKGROUND OF THE INVENTION

Conventional data processing systems include tools that can perform functions on data. An example of a conventional data processing system is a database management system (DBMS). Examples of tools provided by a data processing system include tools that input, organize, manipulate, sort, process, store and output data.

An important function of data processing systems involves sorting data. A sorting routine or algorithm can order data, e.g., into a sequential list based on a search index. The sorting routine can place the data in an order such that traversal of the list, for the purpose of locating a particular item included in the list, is intuitive and fast.

Data in a database can be segregated into components conventionally referred to as “records.” A record in the database can include various subcomponents also referred to as “fields.” When a database of records is sorted, a particular field of the records can be selected as a sort index. In sorting, all the records of the database can be sorted based on the contents of the sort index field. Conventionally, the records can be sorted using an algorithm in a descending or an ascending order based on contents of the sort index field of the records. For example, numerical data in a sort index field can be sorted from lowest value to highest value. Alphabetical data can be ordered alphabetically. Sorting rules can be used to order records containing various forms of data. For example, sorting rules can be used in sorting records including mixed data having alphanumeric characters, strings, non-alphanumeric characters, and wild-cards.

Conventional sorting algorithms organize information by arranging the information sequentially. Sequential sorting is very efficient at organizing data into a logical arrangement that is easily analyzed by both humans and computers alike. Although well organized, this type of sorting has several shortcomings. An exemplary shortcoming of conventional sorting algorithms is perhaps most evident when a sorted list is of great length. Sequential sorting routines are particularly useful for finding items near the beginning of, or end of, a long list items. Sometimes, however, a user has to search for something in the middle of the long list. In such a case, the user can be required to scroll through many items on the long list, until the desired item is reached. Illustrative of the case is a wireless handheld device such as, e.g., a cellular phone, including a list of 50 contacts sorted in alphabetical order by last name. Using such a list, it is more difficult to find a contact whose name begins with the letter “P” than to find a contact whose name begins with an “A.”

### SUMMARY OF THE INVENTION

In an exemplary embodiment of the present invention, a communication device can include a processor operative to access a plurality of records and position information, wherein the processor is operative to sort the plurality of records based on a first detected position and is operative to resort the records based on a second detected position.

The communication device can further feature a detector that detects a change in position of a user device.

The communication device can include: a detector having a positioning device, a global positioning system, a receiver operative to receive position information, or three or more receivers operative to detect by triangulating a position.

The communication device can further include a transmitter that can transmit a change in position of the user device, a storage device operative to store and retrieve records and position information, or a zone detector operative to receive zone information.

The communication device can include a zone detector that can respond to the zone information wherein the zone information can be externally definable and responsive to a user signal, or a network signal.

The communication device can further feature a user interface wherein the zone detector can include detecting a zone responsive to a user input signal, a network signal, a position detector, a user identifiable zone, and a non-user identifiable zone.

In an exemplary embodiment of the present invention, a system, method, and computer program product for sorting data records can include determining a position of a user within a zone, sorting data records according to proximity to the position of the user, and resorting the data records upon a change in the position of the user.

Advantageously, the method can have features including determining the zone of the position of the user, receiving the position of the user, or polling a device associated with the user to determine the position of the user. In another exemplary embodiment, the method can include dynamically detecting the change in the position of the user, resorting the data records upon a change in the position of the user to within another zone, or polling a device associated with the user to determine the change in the position of the user.

The data records can include: items on a shopping list, wherein the zone can include an aisle or floor of a store; items slated for delivery including mail or packages; radio stations, wherein the zones can include a geographic area; or attractions at a theme park, wherein the zones can include events, rides, restaurants, or buildings of the theme park.

The method can further feature, in an exemplary embodiment, sorting the data records based on a sorting index; or sorting the data records based on another sorting index. The sorting indices can include cost, time of an event, duration of the event, distance to the event, or wait time for the event.

The zone can include in an exemplary embodiment, an externally definable zone, definable by, e.g., a user signal or a network signal, a user identifiable zone, or a non-user identifiable zone.

Further features and advantages of the invention, as well as the structure and operation of various embodiments of the invention, are described in detail below with reference to the accompanying drawings. In the drawings, like reference numbers generally indicate identical, functionally similar, and/or structurally similar elements. The drawing in which an element first appears is indicated by the leftmost digits in the corresponding reference number.

### BRIEF DESCRIPTION OF THE DRAWINGS

The foregoing and other features and advantages of the invention will be apparent from the following, more particular description of a preferred embodiment of the present invention, as illustrated in the accompanying drawings.

FIG. 1 illustratively depicts an exemplary embodiment of a block diagram of an exemplary system that can use the present invention;

FIG. 2 illustratively depicts an exemplary embodiment of a flow diagram according to the present invention;

FIG. 3 illustratively depicts an exemplary embodiment of a flow diagram according to the present invention; and

FIG. 4 illustratively depicts an exemplary display of an exemplary implementation embodiment of a theme park attraction according to the present invention.

### DETAILED DESCRIPTION OF AN EXEMPLARY EMBODIMENT OF THE INVENTION

A detailed description of a preferred embodiment of the present invention is included below. While specific implementations are discussed, it should be understood that this is done for illustration purposes only. A person skilled in the relevant art will recognize that other components and configurations may be used without parting from the spirit and scope of the invention.

### OVERVIEW OF THE INVENTION

Whereas conventional sorting algorithms sort a list of items based upon relationships between data, proximity sorting according to the present invention can use external data to organize information. In an exemplary embodiment, proximity sorting according to the present invention, can organize data such that items physically closest to a wireless user device can be placed toward the top of a sorted list. Items furthest from the wireless user device can be moved toward the bottom of the sorted list, in the exemplary embodiment. Proximity sorting according to the exemplary embodiment of the present invention can be accomplished by establishing a relationship between internal data, and an external physical representation of the data. The establishment of the relationship can be done with various levels of resolution depending on available technology, in the exemplary embodiment.

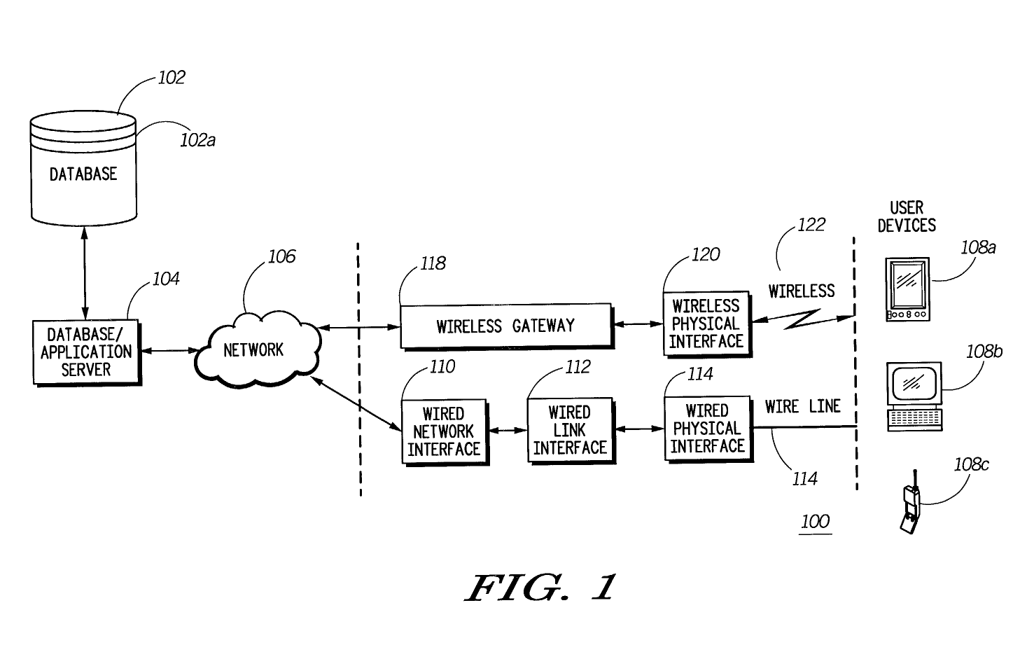

FIG. 1 depicts an exemplary embodiment of a system 100 illustrating an exemplary implementation environment for the present invention. The system 100 of the present invention, in an exemplary embodiment, can include a communications network 106, including various wireline or wireless communication links, which can couple a database 102 (which can in turn be coupled to a database application server 104) to a user device 108. User device 108, in an exemplary embodiment, can include any of various computing or communications devices including, e.g., a wireless phone; a pager (one-way or two-way); a Palm Pilot, or other personal digital assistant (PDA) 108a; a desktop, handheld, notebook, laptop, or palm-top computer 108b; or any other computing, communications or telephony device 108c. An exemplary communications link of network 106, can include the global, distributed Internet network, which can include various interconnected (public and/or private) networks that can be linked together and can communicate by a set of standard protocols (such as, e.g., wireless access protocol (WAP), and transmission control protocol/Internet protocol (TCP/IP)). As already noted, network 106 can include various wireline and wireless links and network components that can support defined protocols. Examples of communications protocols can include, e.g., global system for wireless communication (GSM), time division multiple access (TDMA) digital cellular digital control channel industry standard (IS-136), code division multiple access (CDMA) digital control channel wireless communication industry standard (IS-95), Bluetooth™, Flex® communication protocol, and ReFlex® communication protocol.

As will be apparent to those skilled in the relevant art, the global Internet is a distributed network of TCP/IP host computing devices that can include world wide web (“web”) servers, commonly referred to as “the web.” The web can refer generally to, e.g., (i) a distributed collection of inter-linked, user-viewable hypertext documents (commonly referred to as web documents, files or web pages) that can be accessible via the Internet and stored on the web servers, and (ii) user and server software components which can provide user access to such documents using the standardized Internet protocol (IP). Currently, an exemplary standard protocol for allowing applications to locate and acquire web documents is hypertext transfer protocol (HTTP), and web pages can be encoded using any of various markup languages including, e.g., hypertext markup language (HTML), Java programming language, and extensible markup language (XML). However, the terms “web” and “world wide web” as used in describing the present invention are intended to encompass other past, present, and future markup languages, programming code, and transport protocols which can be used in place of (or in addition to) HTML and HTTP.

A web site can include a web server, i.e., a computer system that can provide informational content to client devices 108 over a network using the standard protocols of the world wide web. Typically, a web site or web server domain can correspond to a particular Internet domain name and can include, e.g., content associated with, e.g., a particular organization or entity. As used herein, the term “web site” can generally encompass, e.g., (i) hardware/software server components that can provide the informational content over the network to client user devices 108, and (ii) the so-called “back end” hardware/software components, including, e.g., any non-standard or specialized components, that can interact with the web server components to provide services for web site users.

As illustratively shown in FIG. 1, system 100 can be used to perform the advantageous processes of the exemplary methods of the following figures. System 100, according to the present invention, can further include various other databases including, e.g., a task list database 102a that can reside in database 102, which can store, e.g., a task list or a list of records such as, e.g., a shopping item list, a to-do list, a list of radio stations, a list of mail to be delivered, a list of events, performances, and list of theme-park rides. The task list database 102a can be accessed by the database/application server 104. The database/application server 104 can communicate with user devices 108 through, e.g., the network 106, and through various interfaces 110-116. It is important to note that the network 106, used in connection with the present invention, can include any of various open or proprietary network standards. In an exemplary embodiment of the present invention, the system interconnections can be based on an open system interconnection (OSI) model as proposed by the International Standards Organization (ISO). The user or user devices 108, as introduced above, can include any of, e.g., a portable telephone, a personal computer, handheld communication devices, or any other devices capable of communicating with the task list database 102a of server 104 through the network 106 of system 100. In an exemplary embodiment, the user devices 108 can include a visual display for displaying information related to the task list database 102a. However, the invention can include, in an exemplary embodiment, user devices 108 of any type, shape, size, and form, capable of communicating information to a user in any form, such as, e.g., in audio, video, text, graphical image and other forms, or in any other forms conceivable by those skilled in the relevant art.

As further shown in FIG. 1, communication with the user devices 108 can be achieved through various interfaces 110-116. Communication can be achieved through any of various wireline 116 or wireless 122 access media at the physical (PHY) level of the OSI model.

In an exemplary embodiment, wireline access 116 can include a wired physical layer interface 114 as part of a physical layer of the OSI model. The wired physical layer interface 114 can interface to a wired link layer interface 112 which can include software at the data link layer of the OSI model. Link layer interface 112 can interface in turn with wired network layer interface 110.

In an exemplary embodiment, wireless access 122 can include a wireless physical layer interface 120 as part of a physical layer of the OSI model. The wireless physical layer interface 120 can interface with, a wireless gateway 118 for wireless transport such as, e.g., a wireless access protocol (WAP) proxy gateway, Reflex, global standard of mobile communications (GSM), time division multiple access (TDMA), code division multiple access (CDMA), and BlueTooth, which can include software at the data link layer of the OSI model.

In an exemplary embodiment, wired network interface 110 and the wireless gateway 118 can each provide access to network 106 for wireline and wireless user devices 100, respectively. The network 106 can include software such as, e.g., Internet protocol (IP) at the network layer of the OSI model, and transmission control protocol (TCP) at the transport layer of the OSI model. TCP and IP are part of the TCP/IP protocol suite of protocols, also often referred to as the TCP/IP protocol stack.

In an exemplary embodiment, the communication of modification of the order of the information displayed of task list database 102a, on user device 108 can be effected, at least partly, through wireless network devices. As described in even more detail below, in addition to the network-level implementation described, the present invention can also be implemented in, e.g., a standalone user device 108 level, where a single user can include a database 102 and a sorting mechanism, or two- or more user devices 108 capable of communicating with one another using databases 102 that can be stored within internal memories of the user devices 108.

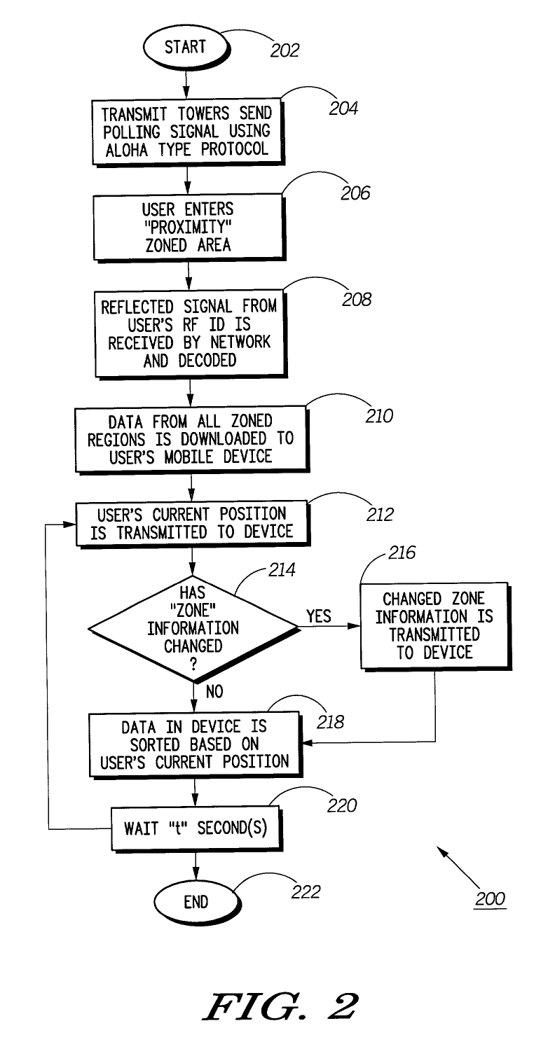

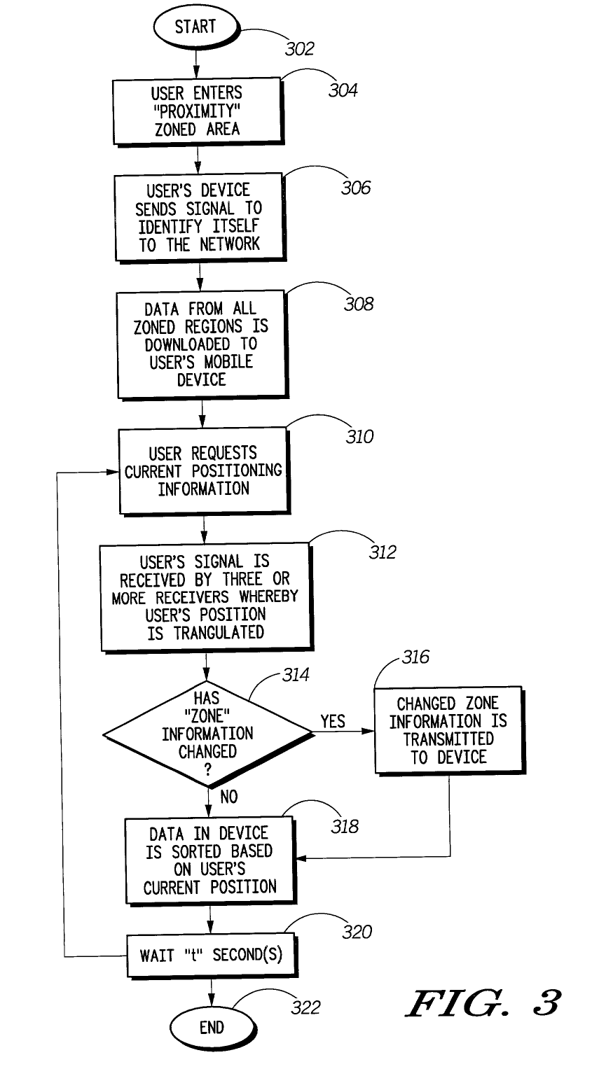

FIGS. 2 and 3 illustratively depict flow charts 200 and 300, respectively, of exemplary embodiments of methods for sorting records of task list database 102a according to proximity order in accordance with the present invention. As stated above, each user can use user devices 108 in communication with task list database 102a.

In its simplest form, in an exemplary embodiment, a single user can use the present invention.

In another exemplary embodiment, two users, who can be part of a group, can use the present invention.

As illustratively shown in FIGS. 2 and 3, described further below, the methods of the present invention can provide, e.g., a task list database 102a as part of database 102 of FIG. 1. A user can originally define the task list. Alternatively, the task list can be network defined. The task list can include, e.g., data relating to a wide range of items, such as, e.g., grocery items, household items, apparel, mail to be delivered, radio stations to be tuned into, weather forecasts, events and other proximity related data.

In another exemplary embodiment, the users can use a previously created task list 102a. Upon request, or automatically, the task list can be transmitted to one or more of the users. The database 102 task list 102a can be provided at the network 106, standalone user, or user device 108 level using any of various well known database application programs such as, e.g., Microsoft Access or Structured Query Language (SQL) Server available from Microsoft Corporation of Redmond, Wash., U.S.A., Oracle available from Oracle Corporation, Informix available from Informix Corporation, IBM DB2 available from IBM Corporation of Armonk, N.Y., U.S.A., and many others. Other database applications can also be used or developed including, e.g., using readily available software development tools offered from and by, e.g., 3COM for a PalmPilot platform, or by Microsoft Corporation, for a Windows CE operating system platform device.

The task list can be created on the database 102 in any of one or more database formats. In an exemplary embodiment, the task list database 102a can be designed including a record for each item in the list. Each record can have a number of fields that can specify various attributes about the item. The fields of each record can be designed to include, e.g., a wide range of data that are related to the items. Such data can be as short as the name of the item and can include other descriptive information about the item. More detailed relevant information depending on the type of item can include, e.g., the item type, manufacturer, size, color, performance, theme park ride, event name, start time, duration, wait time and other helpful information that can also be stored in the task list database 102a. Of course, such records and fields can be modified, added to, or deleted as necessary to accommodate a particular application.

FIG. 2 illustratively depicts an exemplary embodiment of flow diagram 200 of the present invention. Flow diagram 200, in an exemplary embodiment can poll any of various passive devices. The flow diagram 200 can begin with step 202 and can continue immediately with step 204.

In step 204 of flow diagram 200, a polling signal can be transmitted to a user associated with user device 108 from, e.g., a transmitter. In an exemplary embodiment, the polling signal can use an ALOHA type communications protocol to communicate with user device 108. As will be apparent to those skilled in the relevant art, the ALOHA protocol is a shared channel, contention-based protocol. From step 204, flow diagram 200 can continue with step 206.

In step 206, the user can enter a zone. A zone can be referred to as a proximity zoned area. A zone can be user definable, or network definable. A zone can be user identifiable, such as, e.g., an aisle in a store, or a floor of a building, or can be non-user identifiable, such as, e.g., a geographic boundary such as a county or a state, or a metropolitan area, or radio listening area. From step 206, flow diagram 200 can continue with step 208.

In step 208, a reflected signal from the user's user device 108 can be received by network 106. In an exemplary embodiment, the reflected signal can include a radio frequency (RF) identifier (ID) and can be decoded. In an exemplary embodiment, the RF ID can correspond to a passive tag, and can identify the device and where the device is located. From step 208, flow diagram 200 can continue with step 210.

In step 210, data from the zones can be downloaded to user device 108 of the user. The data could include various records of, e.g., the task list included in task list database 102a. From step 210, flow diagram 200 can continue with step 212. In step 212, a position of the user device 108 can be determined. In an exemplary embodiment, the position of the user device 108 can be transmitted to the user device 108. In another exemplary embodiment, the position can be determined by a detector. In yet another exemplary embodiment, the zone can be determined. In another exemplary embodiment, the zone can be detected. In another, the zone can be transmitted to the user device 108. From step 212, flow diagram 200 can continue with step 214.

In step 214, a determination can be made whether the zone has changed. When the zone is determined to have changed, then in an exemplary embodiment, flow diagram 200 can continue with step 216. When instead, the zone is determined not to have changed, then in an exemplary embodiment, the flow diagram 200 can continue with step 218.

In step 216, in an exemplary embodiment, the changed zone information determined in step 214 can be transmitted to user device 108. From step 216, flow diagram 200 can continue with step 218.

In step 218, the data records in user device 108, can be sorted according to proximity to the current position of the user device 108, as determined in the foregoing steps. In another exemplary embodiment, another sorting index than proximity to the user device can be used, or can be used in addition to sorting based on proximity. For example, task list records can be sorted according to, e.g., cost, time, distance, duration, relative time, wait time, time of an event, duration of an event, and any other relevant sort indexes. From step 218, flow diagram 200 can continue with step 220.

In step 220, in an exemplary embodiment, a threshold time duration can be tracked. For example, after a time duration of “t” number of seconds, e.g., 30 seconds, flow diagram 200 can continue with step 212. Flow diagram 200 can continue continuously looping back from step 220 to step 212. In an exemplary embodiment, the flow diagram 200 can eventually break, such as, e.g., upon the occurrence of power down of user device 108, accordingly, flow diagram 200 can continue with step 222, which can immediately end.

FIG. 3 illustratively depicts an exemplary embodiment of flow diagram 300 of the present invention. Flow diagram 300 illustrates an exemplary embodiment using an active device for identification. In an embodiment, the identification device can also use a passive device that can become active when brought within range of a signal. Flow diagram 300 can begin with step 302 and can continue immediately with step 304.

In step 304, a user, who can be associated with a user device 108, can enter a zone. A zone can be referred to as a proximity zoned area. A zone can be user definable, or network definable. A zone can be user identifiable, such as, e.g., an aisle in a store, or a floor of a building, or can be non-user identifiable, such as, e.g., a geographic boundary such as a county or a state, or a metropolitan area, or radio listening area. From step 304, flow diagram 300 can continue with step 306.

In step 306, the user device 108 can be identified by the network 106. In an exemplary embodiment, the user device 108 of the user can send a signal identifying the user device 108 to the network 106. The identification can occur dynamically and continuously. In an exemplary embodiment, the identification can occur periodically or aperiodically. In an exemplary embodiment, an identification signal from the user's user device 108 can be received by network 106. In an exemplary embodiment, the identification signal can include, e.g., a radio frequency (RF) identifier (ID) and the user device 108 can proceed to decode the RF ID. From step 306, flow diagram 300 can continue with step 308.

In step 308, data from zones, such as, e.g., records of task list database 102a can be downloaded to the user device 108. From step 308, flow diagram 300 can continue with step 310.

In step 310, user device 108, in an exemplary embodiment, can request position information. In an exemplary embodiment, the positioning information can be transmitted to the user device 108. In another embodiment, the position information can be detected. In one exemplary embodiment, the position of user device 108 can be detected using triangulation. From step 310, flow diagram 300 can continue with step 312.

In step 312, a position of the user device 108 can be determined. In an exemplary embodiment, the position of the user device 108 can be transmitted to the user device 108. In another exemplary embodiment, the position of the user device 108 can be determined by a detector that can be integrated in the user device 108. In yet another exemplary embodiment, a zone that the user device 108 is within can be determined. A zone can include, e.g., an externally definable zone definable by a user signal or a network signal, a user definable zone, or a non-user definable zone. Examples of zones can include, e.g., aisles or floors of a store; mail drop locations or mailboxes; geographic areas or regions such as, e.g., states, counties, towns, villages, and cities; radio station broadcast ranges; sections of a theme park such as, e.g., rides, events, restaurants, buildings, refreshment stands, or concession stands; and tangible or intangible three dimensional areas, regions, and altitudes. A zone can be identified and a zone database can store a definition of the zone and a zone identifier (ID). For example, the position of user device 108 can be determined and then the position can be used to query a database to determine the zone corresponding to the position. Alternatively, the zone of user device 108 can be determined directly and if determined remotely from the user device 108, can be communicated to or transmitted to the user device 108. In another exemplary embodiment, the zone can be detected. In an exemplary embodiment, a global positioning system (GPS) system can be used to determine the position of the user device 108. In an exemplary embodiment, an altimeter can be used to determine information such as, e.g., a floor of a mall that the user device 108 is on. In another exemplary embodiment, the zone can be transmitted to the user device 108. In an exemplary embodiment, a signal from the user device 108 can be received by three or more receivers whereby the position of the user device 108 and the user can be determined by triangulating the position. From step 312, flow diagram 300 can continue with step 314.

In step 314, a determination can be made whether the zone has changed. When the zone is determined to have changed, then in an exemplary embodiment, flow diagram 300 can continue with step 316. When instead, the zone is determined not to have changed, then in an exemplary embodiment, the flow diagram 300 can continue with step 318.

In step 316, in an exemplary embodiment, the changed zone information determined in step 314 can be transmitted to user device 108. From step 316, flow diagram 300 can continue with step 318.

In step 318, the data records in user device 108, can be sorted according to proximity to the current position of the user device 108, as determined in the foregoing steps. In another exemplary embodiment, another sorting index than proximity to the user device can be used. For example, task list records can be sorted according to, e.g., cost, time, distance, duration, relative time, wait time, time of an event, duration of an event, and any other relevant sort indexes. From step 318, flow diagram 300 can continue with step 320.

In step 320, in an exemplary embodiment, a threshold time duration can be tracked. For example, after a time duration of “t” number of seconds, e.g., 30 seconds, flow diagram 300 can continue with step 312. Flow diagram 300 can continuously loop back from step 320 to step 312. In an exemplary embodiment, the flow diagram 300 can eventually break, such as, e.g., upon the occurrence of power down of user device 108, accordingly, flow diagram 300 can continue with step 322, which can immediately end.

An exemplary use of the present invention can be a user entering a supermarket with a user device 108a. The user could use a stylus to open a grocery list, in the exemplary embodiment. The grocery list could be relatively long, e.g., including 28 items, and could be sorted alphabetically, initially. Unfortunately, the items for purchase at a supermarket are not normally organized alphabetically. Advantageously, the user can select a proximity sort, according to the present invention. The grocery list can then be reorganized and can be displayed in order with the items physically located nearest to the user at the top, and ordered by distance from the user. Advantageously, the information could also be ordered by aisle, or other zone grouping, or by floor, when the store is laid out on multiple floors as in the case of a mall. As the user makes the user's way around the supermarket, in an exemplary embodiment, the grocery list can be reordered automatically, dynamically, or upon a manual selection. Thus, the user can advantageously check off items from the list and the remaining items can continue to be reorganized by proximity. Advantageously, the list can also of course be reorganized by another sorting index, such as, e.g., cost. So when the user is working on a limited budget, the list can be reordered to remain within, e.g., a limited budget, which can be inputted by the user. The device can be included as part of a grocery cart, in one exemplary embodiment, and a list could be inputted by the user, upon arrival at the supermarket by means of an input device, such as, e.g., a smart card device.

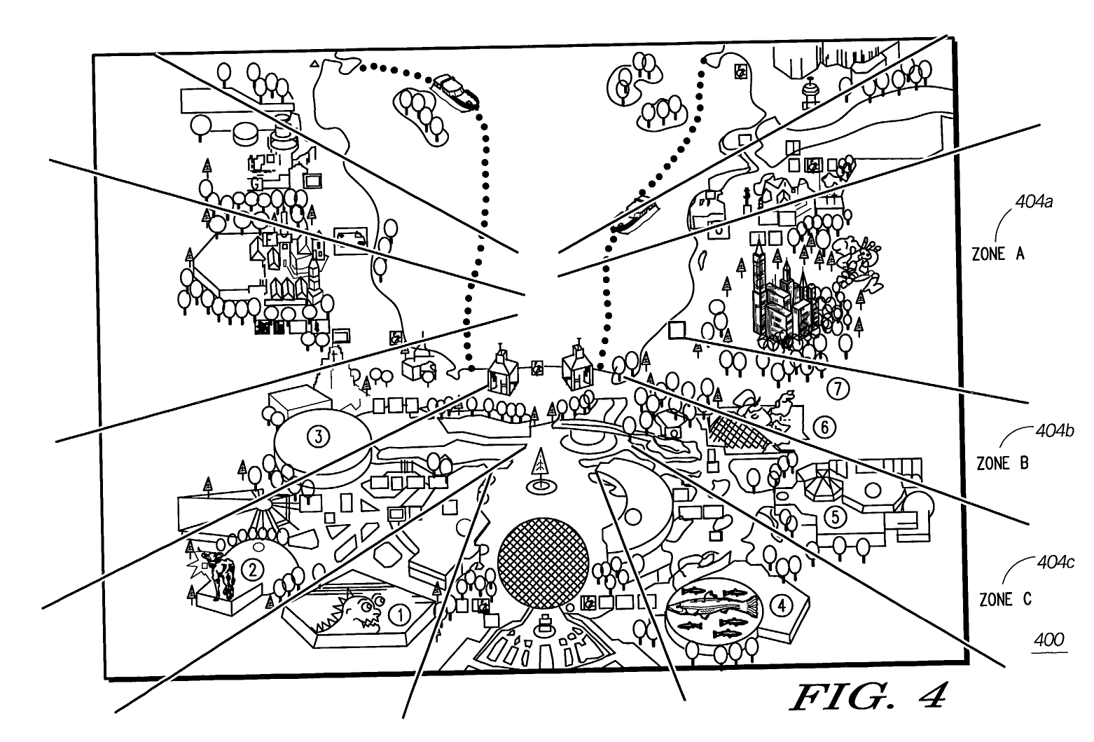

FIG. 4 illustratively depicts an exemplary display of an exemplary implementation embodiment of a theme park attraction according to the present invention. As shown in the table below, a list of attractions can be sorted by distance from the position of the user.

Current Time: 10:00 AM

| Reference | Show | Wait Time | Distance |
|---|---|---|---|
| 1 | Ellen's Energy Adventure | 15 minutes | 50 meters |
| 2 | Body Wars | 10 minutes | 76 meters |
| 3 | Test Track | 75 minutes | 100 meters |
| 4 | Living Seas | 25 minutes | 300 meters |
| 5 | Living With the Land | 20 minutes | 375 meters |
| 6 | Journey into Imagination | 05 minutes | 380 meters |
| 7 | Honey I Shrunk the Kids | 20 minutes | 380 meters |

The sorted list can be displayed to the user. The list as shown can include, e.g., exemplary wait times and distances to the attractions.

In an exemplary embodiment, a family can enter a theme park such as, e.g., Disney's EPCOT center. When the family is entering for the first time, the family of users could be overwhelmed by the size of the theme park. The family users could refer to a wireless user device according to the present invention, to simplify their task. Advantageously, with a few user selections on the screen of user device 108a, a list of available attractions could be displayed for the users. Other information about the attractions could also be provided such as, e.g., wait times, duration of rides, commencement of the next ride, popularity, or other information. Selection of a proximity search, selecting an ordering based on, e.g., the proximity of the attractions, and the starting times of the attractions, according to an exemplary embodiment of the present invention, can result in an ordered list of attractions sorted according to the selected criteria, as shown in the table above. The list can include information about the attractions such, as, e.g., the distance to the attractions, nearby rides or attractions on the way, a suggested optimal path to arrive at the attraction, a recommended pace to reach the attraction in time (e.g., a leisurely walk, or a fast paced walk), a countdown until the start of the attraction, and suggestions, special offers, or advertising for suggested locales for other services such as, e.g., restaurants nearby, and ice cream stands. The device can have a position determining device which can be used to constantly update the data included with the list of attractions. If the users get lost, the device can direct them through alternative paths to desired attractions as well.

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. A method for sorting data records comprising:
(a) determining a position of a user within a zone; and
(b) sorting data records, wherein said data records are associated with a related zone, wherein sorting is according to proximity of said related zone of said data records in relation to said position of the user.

2. The method according to claim 1, further comprising:
(c) resorting said data records upon a change in said position of the user.

3. The method according to claim 2, wherein said step (c) comprises at least one of:
(1) dynamically detecting said change in said position of the user;
(2) resorting said data records upon a change in said position of the user to within another zone;
(3) resorting upon detecting a change in said position of the user to a new zone;
(4) resorting upon receiving a resort request;
(5) resorting upon receiving a resort request from the user; and
(6) polling a device associated with the user to determine said change in said position of the user.

4. The method according to claim 1, wherein said step (a) comprises at least one of:
(1) determining said zone of said position of the user;
(2) receiving said position of the user; and
(3) polling a device associated with the user to determine said position of the user.

5. The method according to claim 1, wherein said data records comprise at least one of:
items on a shopping list, wherein said zone comprises at least one of an aisle and a floor in a store;
items slated for delivery comprising at least one of mail and packages;
radio stations, wherein said zones comprise a geographic area; and
attractions at a theme park, wherein said zones comprise at least one of events, rides, restaurants, and buildings of said theme park.

6. The method according to claim 1, further comprising at least one of:
(c) sorting said data records based on a sorting index; and
(d) sorting said data records based on another sorting index.

7. The method according to claim 6, wherein said sorting index and said other sorting index include at least one of:
cost;
time;
duration;
distance;
alphabetical order; and
wait time.

8. The method according to claim 1, wherein said zone comprises at least one of:
an externally definable zone, definable by at least one of a user signal and a network signal;
a user identifiable zone; and
a non-user identifiable zone.

9. A communication device comprising:
a processor operative to access a plurality of records and position information,
wherein the processor is operative to sort said plurality of records based on a first detected position.

10. The communication device according to claim 9, wherein said processor is further operative to resort said records based on a second detected position.

11. The communication device according to claim 9, further comprising:
a detector operative to detect a change in position of a user device.

12. The communication device according to claim 11, wherein said detector comprises at least one of:
a positioning device;
a global positioning system;
a receiver operative to receive position information; and
three or more receivers operative to detect by triangulating said position.

13. The communication device according to claim 9, further comprising:
a transmitter operative to transmit said change in position of said user device.

14. The communication device according to claim 9, further comprising:
a storage device operative to store and retrieve said records and position information.

15. The communication device according to claim 9, further comprising:
a zone detector operative to receive zone information.

16. The communication device according to claim 15, wherein said zone detector is responsive to said zone information wherein said zone information is externally definable.

17. The communication device according to claim 16, wherein said externally definable zone information is responsive to at least one of:
a user signal; and
a network signal.

18. The communication device according to claim 15, further comprising a user interface wherein said zone detector is operative to detect zone responsive to at least one of:
a user input signal;
a network signal;
a position detector;
a user identifiable zone; and
a non-user identifiable zone.

19. A system for sorting data records comprising:
means for determining a position of a user within a zone; and
means for sorting data records according to proximity to said position of the user.

20. The system according to claim 19, further comprising:
means for resorting said data records upon a change in said position of the user.

21. A system operative to sort data records comprising:
a position detector operative to determine a position of a user within a zone;
a proximity sorter operative to sort data records according to proximity to said position of the user.

22. The system according to claim 21, further comprising:
a proximity resorter operative to resort said data records upon a change in said position of the user.

23. A computer program product embodied on a computer readable medium, the computer program product including program logic comprising:
program code means for enabling a computer to determine a position of a user within a zone; and
program code means for enabling the computer to sort data records according to proximity to said position of the user.

24. The computer program product of claim 23, further comprising:
program code means for enabling the computer to resort said data records upon a change in said position of the user.
